(19) United States
(12) Patent Application Publication
(10) Pub. No.: US 2007/0011936 A1
(43) Pub. Date: Jan. 18, 2007

(54) Device to illuminate soft fishing baits

(76) Inventor: Richard J. Marino, Bogota, NJ (US)

Correspondence Address: Richard J. Marino, 35 Oakwood Avenue, Bogota, NJ, 07603, US

(21) Appl. No.: 11/401,046

(22) Filed: Jun. 5, 2006

Related U.S. Application Data
(60) Provisional application No. 60/673,890, filed on Apr. 16, 2005.

(51) Int. Cl. A01K 85/01

(52) U.S. Cl. 43/17.6

(57) ABSTRACT

My invention, entitled “Device to Illuminate Soft Fishing Baits” is a device utilizing an illuminating unit which is inserted inside the body of a flexible soft fishing bait at the time of its molding to provide a light source from within the actual fishing bait which will attract various species of fish to the bait.

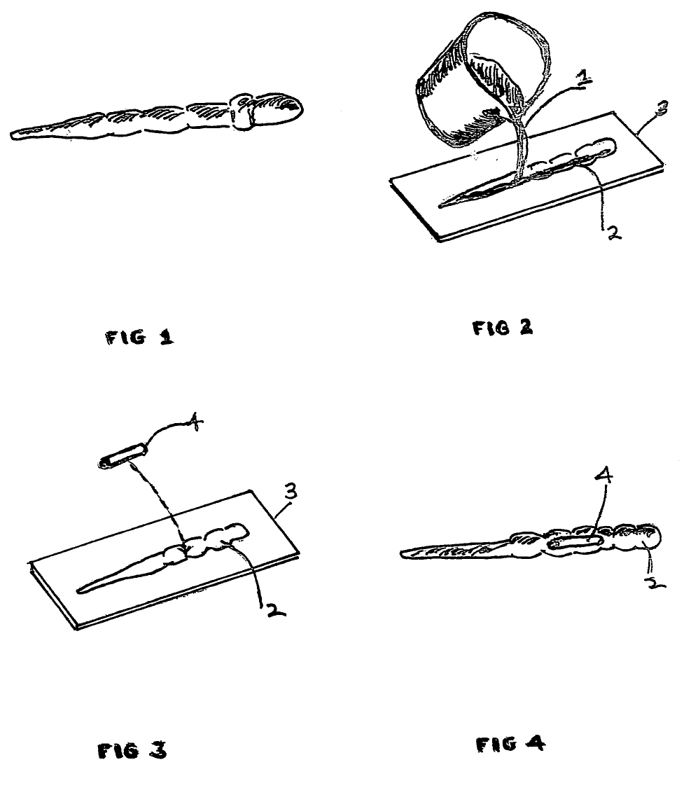

Be it known that Richard J Marino, a citizen of the United States of America, residing at 35 Oakwood Avenue, Bogota, N.J. 07603 has invented a device to illuminate soft plastic fishing baits. When attached to a fishing line and activated, the soft bait illuminates from within to attract various species of fish to the bait.

Liquid plastic, readily available on the retail market, is heated to 325 degrees stirring frequently until warm. The liquid is poured into a mold which is shaped to replicate the desired soft bait. The most common being a worm, crawfish, frog or various species of insects. While the plastic is still in its warm, liquid state in the mold, a Glow Stick (cylinder shaped tube or container, which is readily available on the retail market, with a composition inside that creates a glow or luminescent effect when mixed) is inserted into the plastic. When the plastic cools it takes the flexible shape of the soft bait mold. The soft bait is then removed from the mold with the illuminating devices implanted inside. Individuals involved in the sport of fishing would attach the soft bait to their fishing line via the numerous methods currently being employed, activate the glowing effect of the soft bait by simply bending the soft bait, allowing the ingredients inside the Glow Stick to mix, and present the lure to the fish being sought. No soft bait is known in the sport of fishing which actually emits a glowing light source from within the soft bait itself.
1) I claim that my invention will, when presented to the various species of fish via the actual sport of fishing, readily attract these fish to the lure because of the illumination from within.

2) 1 also claim that my invention will provide an illuminating soft bait device for attracting fish which is both inexpensive and durable.

1. I claim that my invention will, when presented to the various species of fish via the actual sport of fishing, readily attract these fish to the lure because of the illumination from within.

2. I also claim that my invention will provide an illuminating soft bait device for attracting fish which is both inexpensive and durable.
